(19) United States
(12) Patent Application Publication
(10) Pub. No.: US 2008/0302309 A1
(43) Pub. Date: Dec. 11, 2008

(54) POULTRY CART AND METHOD AND APPARATUS FOR KILLING POULTRY

(76) Inventor: Brian Herman, Mildmay (CA)

Correspondence Address: BERESKIN AND PARR, 40 KING STREET WEST, BOX 401, TORONTO, ON, M5H 3Y2, CA

(21) Appl. No.: 12/132,982

(22) Filed: Jun. 4, 2008

(30) Foreign Application Priority Data
Jun. 5, 2007 (CA) 2591101

(51) Int. Cl. A01K 31/07; A22B 3/00

(52) U.S. Cl. 119/453; 452/52

(57) ABSTRACT

A poultry cart has one or more side doors that may be opened to expose substantially the entire side of the cart. The cart has no more than one interior vertical post on this side or has clear openings on this side across the width of each door. A process for killing poultry comprises steps of putting birds into a cart, moving the cart to a killing area, killing the birds, and dumping the birds out of the cart. The cart may be dumped by leaning it on its side such that doors on a side open and allow the birds to fall out.

This application claims priority from Canadian patent application number 2,591,101 filed Jun. 5, 2007 which is incorporated herein in its entirety by this reference to it.

### FIELD

This document relates to poultry handling or management.

### BACKGROUND

The following is not an admission that anything discussed herein is citable as prior art, information available to the public, or part of the common knowledge of persons skilled in the art.

Devices and methods for efficiently moving poultry are of general concern to the poultry industry. Further, it is sometimes necessary to transport and kill large numbers of birds for example when a flock of laying hens are beyond the age of economical egg production and there is no market for their meat or because of or in preparation for an outbreak of a disease. In particular, the threat of the spread of avian flu makes it desirable to have devices or methods available to rapidly and humanely kill a poultry flock.

Examples of devices or processes for handling or managing poultry are described for example in the following U.S. patents:

U.S. Pat. No. 5,469,815 (Stross) discloses a method of loading live poultry. Firstly, provide a transport vehicle having a plurality of empty poultry crates, a trailer having a two tiered trailer mounted conveyor, and a plurality of interconnectable two tiered conveyor sections. The trailer mounted conveyor and the conveyor sections both have a top tier and a bottom tier. Secondly, deploy the trailer mounted conveyor so that a first end extends into the freight compartment of the transport vehicle, and deploy the two tiered conveyor sections so that they extend from a second end of the trailer mounted conveyor into an enclosure containing live poultry. Thirdly, send poultry crates continuously along the trailer mounted conveyor and the conveyor sections from the freight compartment of the transport vehicle to the enclosure on one of the top tier and bottom tier. Fourthly, load the live poultry into the poultry crates at the enclosure and send the poultry crates containing live poultry continuously along the conveyor sections from the enclosure to the freight compartment of the transport vehicle on the other of the top tier and bottom tier.

U.S. Pat. No. 4,955,318 (Melhorn et al.) discloses an easily transportable poultry or animal cart that is constructed of a plurality of individual cages, each cage equipped with a horizontally bifolding door at one end and a horizontally sliding door along an adjacent side. The cages may be either permanently joined during construction or temporarily joined if a smaller cart or greater versatility is desired. The cart is wheeled for mobility. The carts may be constructed as “mirror images,” so that two carts may be joined together with their respective bifold doors at opposite ends of the assembly, and their respective sliding doors along a common side.

U.S. Pat. No. 4,301,769 (Mola) discloses an apparatus that is provided for loading poultry from a rearing house into a series of hen-coops arranged in vertical rows on a transport vehicle. The apparatus includes an elevator conveyor which takes the animals from an assembly enclosure to a vehicle movable transversely of the elevator conveyor. This vehicle comprises a first horizontal conveyor extending parallel to the longitudinal axis of the vehicle and arranged to receive animals from the elevator conveyor, an adjustable-inclination conveyor disposed alongside the first horizontal conveyor, a second horizontal conveyor disposed transversely to the first horizontal conveyor and arranged to transfer animals from that conveyor onto the adjustable-inclination conveyor, and a pneumatic forced-delivery unit located transversely at the output end of the adjustable inclination conveyor.

U.S. Pat. No. 5,975,029 (Morimoto et al.) discloses a method and device for collecting poultry and transporting the poultry to a slaughterhouse, in which the birds are at least partially made unconscious prior to their arrival at the slaughterhouse. Prior to or during their collection, the birds can be conveyed through a tunnel containing a stunning gas. A goods vehicle for carrying crates or containers with poultry to a slaughterhouse can be provided with means for introducing a stunning gas into the crates or containers.

U.S. Pat. No. 5,635,629 (Imai et al.) discloses a knock sensor for which a fabrication process is simple and moreover which can detect up to a high-frequency region is provided. A sensing element 11 composed of a semiconductor the weight (mass) thereof being 1 g or less and a signal processing circuit 11 are mounted on a fixing pedestal 9. The fixing pedestal 9 is fixed to a connector 2 side by means of adhesive or the like. Additionally, the connector 2 is fixed by means of caulking 16 of a housing 1. As a result thereof, the sensing element 11 is disposed within a space formed by the fixing pedestal 9 and the housing 1.

U.S. Pat. No. 5,470,194 (Zegers) discloses in a method for unloading a poultry transport container, which comprises at least one loading tray with a side unloading flap, the end of a discharge conveyor is applied from the side of the unloading flap closely above the loading tray. This end is gradually moved towards the side of the loading tray opposite the unloading flap, thus forcing the poultry to take place onto the discharge conveyor. The loading tray, the discharge conveyor or both may be displaceable for obtaining their relative movement.

U.S. Pat. No. 6,135,872 (Freeland et al.) discloses a method and apparatus for unloading poultry as disclosed. A chute (35) is placed proximate the door of a coop. The door is opened and the poultry are urged out of the coop onto the chute (35). The poultry then slide down the chute (35) onto a conveyor (11), (15) which ultimately transfers the poultry to a gas stun vessel (25). The poultry are then transferred to a shackle line where they are shackled, without a full lift, and then proceed to an electrical stun (72) and killer (73). The gas stun vessel (25) includes a static mixer (53) for effectively mixing the CO2 and air before delivery to the gas stun vessel (25).

U.S. Pat. No. 6,848,987 (Draft) discloses a method for the preparation of slaughter of poultry is provided that includes conveying the poultry in cages to at least one gassing chamber to sedate and render the poultry unconscious without killing them.

U.S. Pat. No. 5,487,699 (Tyrrell et al.) discloses an apparatus for gas stunning of poultry in open top drawers (22) comprises a tank (10) holding a heavier than air stunning gas such as a mixture argon and carbon dioxide. A lowering conveyor (24) receives the poultry-containing drawers (22), lowers them into the tank and delivers them to the infeed end of a series of conveyors (28) which transport the drawers (22) through the tank to the base of a lifting conveyor (32) which lifts the drawers and delivers them to the infeed end of a conveyor (34) which transports the dead poultry away for slaughtering. The conveyors (24, 28) are provided with covers (26, 30) to prevent the poultry escaping from the drawers. The drawers (22) are moulded with apertured sides and bases to allow penetration of the gas into the drawers so that the poultry is exposed to the gas for a time sufficient to kill the poultry, or at least render the poultry anoxic.

U.S. Pat. No. 6,174,228 (Grimsland et al.) discloses A method and apparatus for the treatment, such as anaesthetization or killing, of poultry by using gas. The gas comprises oxygen and carbon dioxide, among other components. During the treatment, the oxygen concentration is kept constant at a normal level (18-22 vol. %). This is important as it allows the poultry to breathe normally while the natural body functions can be maintained in their normal state until anaesthetization takes place. The concentration of carbon dioxide is increased either continuously or discontinuously. Accordingly, it is possible to anaesthetize poultry before slaughter in a way which produces low levels of stress and discomfort in the poultry while, at the same time, the quality of the meat is better than with the use of traditional methods. In the apparatus, the poultry are exposed to the gas in a chamber (1). The apparatus may include a belt conveyor (5) and can be separated into three treatment zones (2, 3 and 4).

### SUMMARY

The following does not define any invention, but only introduces the reader to the invention or to the more detailed discussion of devices or processes to follow.

A cart for transporting poultry is described having doors on a side. The cart is configured to have few restrictions interfering with removing poultry through the doors. Without limitation, the cart may be useful for the ordinary movement of poultry within or out of a barn, or for moving poultry in a method or system of killing poultry as described herein.

A method and system of killing poultry are described in which birds are loaded into a cart, the cart is moved to a killing area, the birds are killed, the cart with dead birds is moved to a further transport or disposal area and the dead birds are removed from the cart. The killing area may be a gas chamber and the birds may be killed by exposing them to a lethal gas. The birds may be removed from the cart by tipping the cart on its side so that the birds fall out of a side door of the cart. The birds may fall from the cart onto a transportation device such as a truck or conveyor, or to a disposal place or device. Without limitation, the method or system of killing poultry may be used to kill surplus poultry or to kill poultry to discourage the spread of disease.

### BRIEF DESCRIPTION OF THE DRAWINGS

FIGS. 1 and 2 are top and front views respectively of a first cart.

FIGS. 3, 4 and 5 are front, top and side views respectively of a second cart.

FIGS. 6A and 6B show perspective and side views of third cart being tilted sideways so as to dump out its contents.

FIG. 7 shows a perspective view of carts as in FIG. 6 in a gas chamber.

FIG. 8 is a schematic plan view of a depopulation system.

### DETAILED DESCRIPTION OF EMBODIMENTS

The following discussion will describe at least one embodiment of each claimed invention. However, since this document may describe multiple inventions, it is possible that an apparatus or process described below may not be an embodiment of a particular claim. Further, the embodiments described below are merely examples or a claimed invention and other embodiments or processes having more, less or different features may also be within the scope of a particular claim.

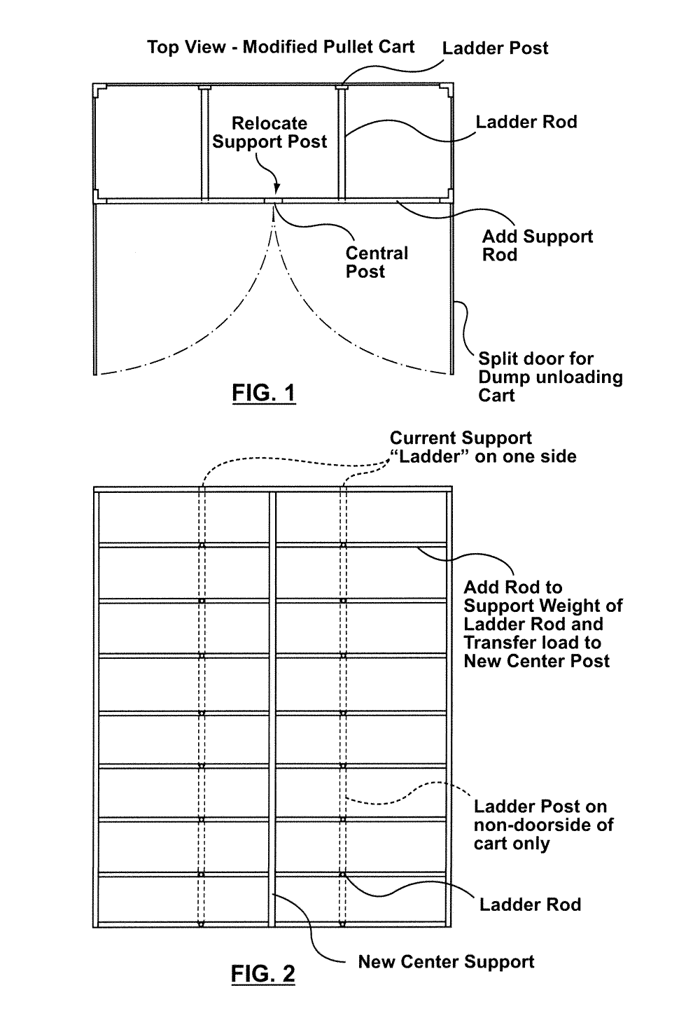

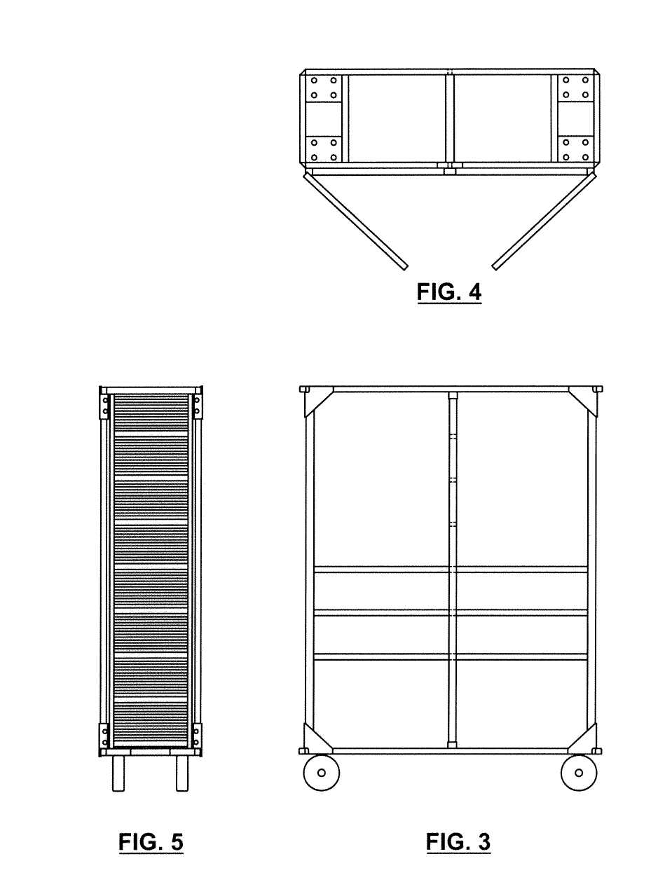

FIGS. 1 to 6 show three versions of carts. The carts have a pair of ends each having a width that is noticeably narrower, for example one half or less, than the length of a side of the cart. The carts have multiple shelves. The ends of the cart may have openings allowing birds to be loaded onto a shelf from an end of the cart. For example, an end of the cart may have flaps between pairs of adjacent shelves and between the top shelf and roof of the cart, the flaps being hinged at the top of the flap so that the flap can be opened, allowing a bird to be placed into the space above a shelf and below the adjacent shelf or roof of the cart. The flap may alternately be closed against a stop so that the birds cannot get back out through the flap.

A side of the cart has one or more doors. A single door may be large enough to span some or all of multiple spaces between shelves within the cart. The one or more doors together may be large enough to, when open, expose all or substantially all of the areas above all of the shelves. A door on the side of the cart may be hinged on a vertical hinge line so as to swing open like a typical door of a house. The doors may be made of a frame and wire mesh, for example 1″ by 2″ welded wire mesh. A latching system for the door allows the door to be latched closed to another door or to a part of a frame of the cart. Optionally, the latch may be spring loaded or otherwise configured to release on the application of sufficient force against the door, or may be connected to a remote actuator to allow the latch to be opened from a side of the cart.

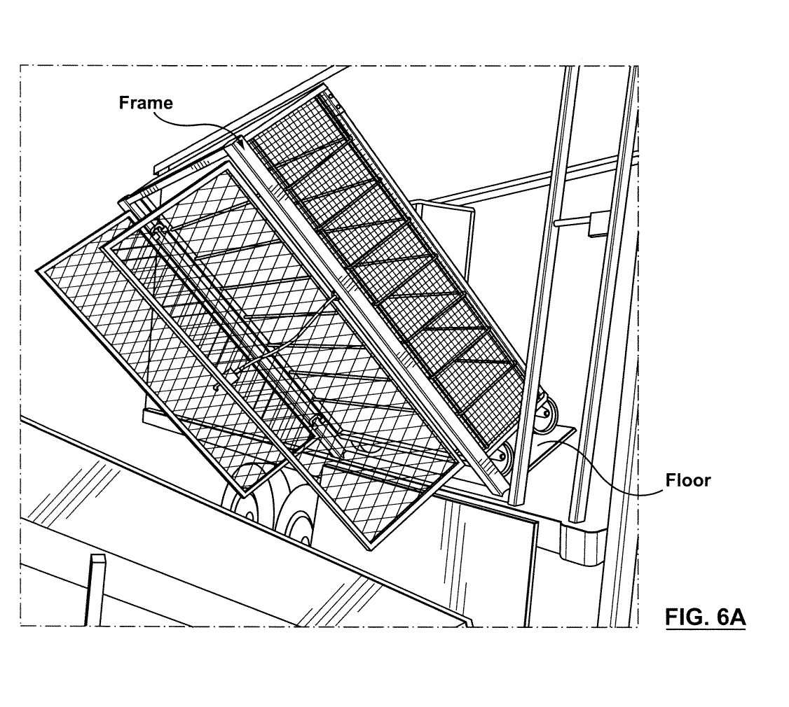

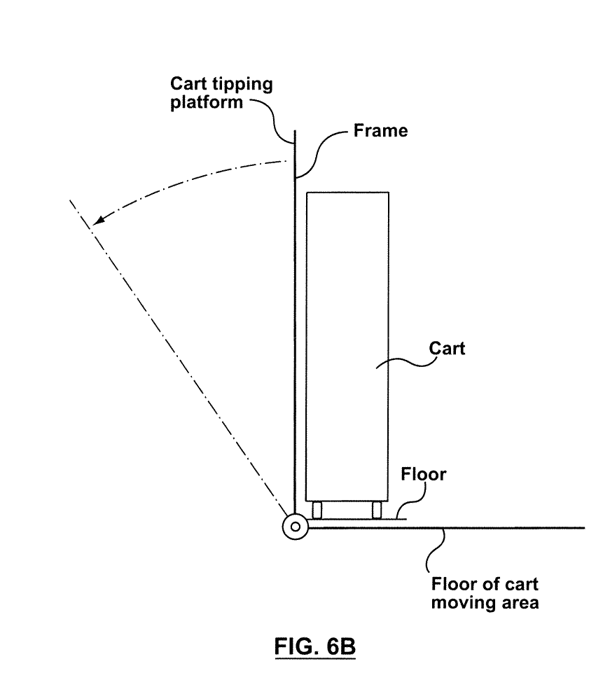

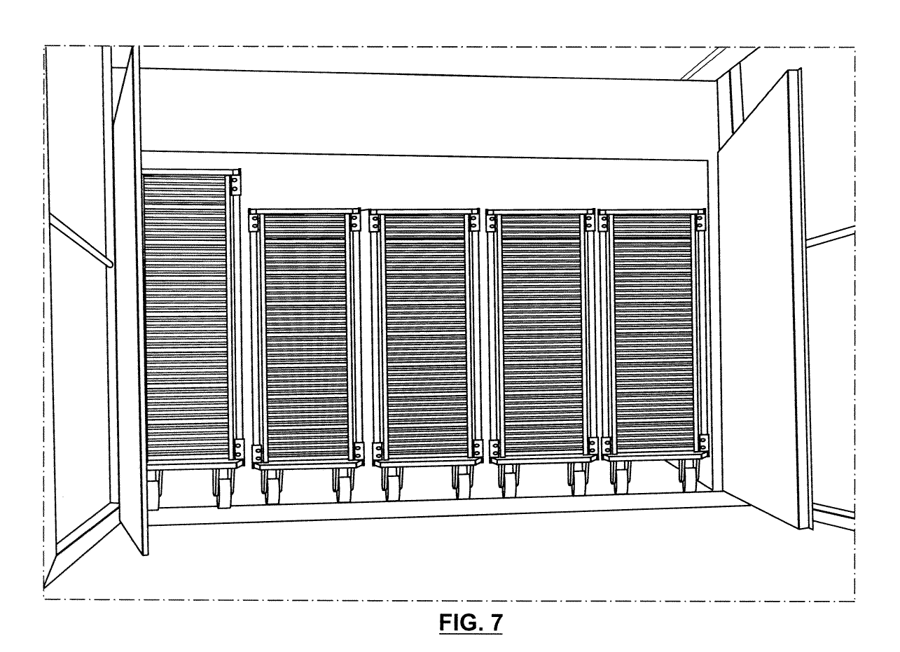

The cart is configured so that bird carcasses will fall out of the side of the cart when the cart is tipped. To that end, restrictions that could hold back the bird carcasses when the cart is tipped are avoided where possible. For example, vertical that might otherwise be used to support the shelves are minimized or eliminated from the side with the doors, or from the opening covered by a door. For example, in the carts of FIGS. 1 to 5, only a single post is used on the side of the cart having doors. The location of this post may correspond with the edges of a pair of doors covering substantially the entire side of the cart. This post may also correspond with an interior partition of a cart that has each shelf divided in half to provide two partitions or cages per shelf and flaps on both ends to allow loading from both ends. In the cart of FIG. 6, there are no interior vertical posts on the side of the cart with doors, the only vertical posts being at the corners or the cart. The generally open access to the shelves through a side door may also be useful for simply easing the manual removal of live birds being removed from a cart or to reduce damage or stress to birds being removed from a cart. Preventing stress or damage to birds is generally important, and particularly important when moving breeding birds.

To help support the weight of the shelves, a rod or other reinforcement may be placed along or under the edge of each shelf adjacent to or near the one or more doors to help support the shelves. This rod or other reinforcement may support the shelves directly or through attachment to ladder rods or other shelf supports running under the shelves across the width of the cart and connected at their other ends to ladder posts on the opposite side of the cart which has no doors. The ends of the rod or reinforcement may in turn be attached to, and supported by, peripheral frame members at the corners of the cart. The rod or other reinforcement may also be supported by, in FIGS. 1 to 5, the central post.

The cart has wheels, for example, casters, to allow the cart to be pushed form place to place.

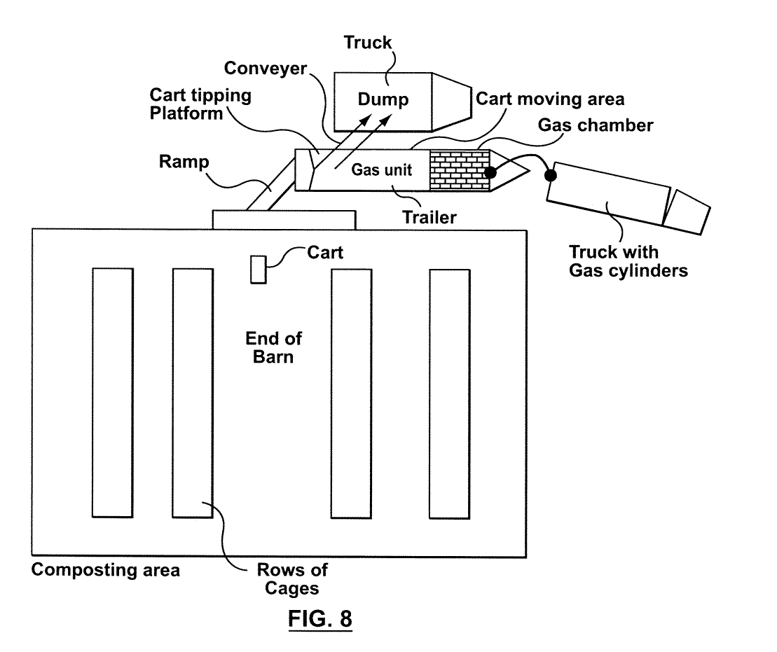

FIGS. 6, 7 shows parts or a poultry killing system and FIG. 8 shows a mobile poultry killing system that has been placed in position at the doors of a poultry barn having rows of caged poultry. The system comprises a gas chamber and a cart, for example as described above, to move birds from the barn into a gas chamber.

Referring to FIGS. 6 to 8, a vehicle, for example a truck and trailer combination, has a flat deck to provide a cart moving area and a gas chamber. The cart moving area of the vehicle includes a cart-tipping platform. The gas chamber includes a source of gas, for example carbon dioxide, and may further have various controls, measuring devices or viewing windows suitable for operation of the gas chamber to kill poultry, for example by a humane application of a lethal concentration of carbon dioxide. A conveyor system, which may be configured to fit on the cart moving area of the vehicle for transport, is set up at the side of the cart moving area. A ramp, which may also be configured to fit on the cart moving area for transport, is installed between a cart accessible area of the barn and the cart moving area of the vehicle. Optionally, a power tailgate or other device to lift carts onto or off of the cart moving area may be used. One or more carts may also be transported to site on the cart moving area of the vehicle.

Referring to FIG. 6, the cart-tipping platform has a floor and a frame and is hinged to an edge of the cart moving area. The cart-tipping platform is configured so that the cart can be rolled onto the floor of the cart-tipping platform and the side of the cart can be received in the frame. The frame of the cart-tipping platform receives and bears against the corner posts of the cart but does not prevent the doors from opening. The cart or cart-tipping platform may then be pushed so that the cart and platform rotate about the hinge line to a position similar to that shown in FIG. 6 in which the doors open and the bird carcasses fall out. The cart and cart-tipping platform may then be pulled back to the starting vertical position and the cart rolled away. If desired, mechanical enhancements may be added to reduce physical labor or enhance safety such as a stop to prevent over-rotation of the cart-tipping platform, latches to releasably fix the cart to the cart-tipping platform and powered systems to tip or return the cart-tipping platform. For example, the cart-tipping platform in FIG. 6 is hydraulically powered.

Referring to FIG. 7, the gas chamber may be long or wide enough to hold multiple carts. The cart moving area may also be wide enough to allow carts to pass or otherwise move around each other. For example space may be provided so that carts may be moved along one side of the cart moving area from the ramp into the gas chamber and along another side of the cart moving area out of the gas chamber, through the cart-tipping platform and back off the ramp while also providing room for people or mechanisms as desired to move the carts.

Referring to FIG. 8, an empty cart, with a latch on its sides doors closed, is rolled through the barn along a row of cages. Live birds are placed into the cart through the flaps at the ends of the cart. The cart is then rolled out of the barn, up the ramp, across the cart moving area of the vehicle, and into the gas chamber. The gas chamber is then closed and filled with gas, for example carbon dioxide, to a lethal concentration for a period of time sufficient to stun then kill the birds. Carbon dioxide and oxygen levels may be monitored during gassing. The gas chamber is then opened and the cart pulled out and its side doors are unlatched. The cart is then rolled out of the gas chamber and onto the cart-tipping platform. The cart is tipped allowing the dead birds to fall out of the cart onto one end of the conveyor belt. The conveyor belt carries the birds to a dump truck and drops them in. When full, the dump truck is driven to a disposal site where the dead birds are dumped out.

Optionally, the dead birds may be composted on site in a composting area. Other biodegradable matter, such as wood shavings, manure or paper products may be added to a composting area to aid in composting. The birds or other matter may also be macerated to aid in composting. The compost pile may be covered or kept indoors and heated or turned etc. to keep animals away, control odors, or provide mixing, air flow or temperatures desirable to increase the rate of composting.

With several carts moving through these steps simultaneously or sequentially, an entire barn may be de-populated quickly. Such a system or method may be used for the destruction of a poultry flock to prevent or control the spread of a disease, for example avian flu. Such a system or method may also be used to dispose of unwanted birds, for example over-age laying hens, if there is no market for them at a processing plant. Currently, most of Canada and many parts of the USA have no plant to ship over-age laying hens to.

In a test run of a process as described above, fifteen carts were used in three batches of five carts each. Ten workers took five carts into the barn and filled them with birds simultaneously. The birds were brought out of the barn in the five carts and pushed onto a power tailgate. The power tailgate was used to lift the carts on to a flat part of the bed of a trailer. The five carts were then pushed and rolled into a gas chamber built on the front of the trailer. Carbon dioxide was injected into the gas chamber to first stun, then kill the birds humanely. After 5 minutes, the initial five carts were removed from the gas chamber and another five carts, which had been filled while the birds in the initial five carts were in the gas chamber, were put into the gas chamber. While the second five carts were in the gas chamber, the first five carts were pushed one at a time onto the cart-tipping platform to dump the dead birds onto a set of small and large conveyor belts which ran continuously to deliver the dead birds to a dump truck. Meanwhile the third set of carts was being filled with more birds. In this way, cart filling, gassing and dumping operations were carried out on a set of carts generally simultaneously and continuously. The power tailgate was positioned adjacent the threshold of the barn doors and could be lowered to the first floor of the barn or raised to a second floor of a barn to move carts between either floor of the barn and the cart-moving area without requiring additional ramps or loading equipment.

Based on trials, it takes about 15 minutes to load about 168 birds into an eight shelf cart partitioned into two sides to provide 16 cages with two people loading the cart and placing 10-12 birds in each cage. With five carts in a set, there are 840 birds per set of carts, allowing 840 birds to be killed in each cycle, a cycle having the steps of loading a set of carts with birds, killing the birds, and unloading the carts. Loading the carts is the longest step in a cycle so with three cycles running simultaneously but with their steps staggered, the process takes about 15 minutes per cycle which is over 50 birds per minute after setting up the equipment and getting all three sets of carts in operation.

I claim:

1. A poultry cart having one or more side doors that may be open to expose substantially the entire side of the cart, the cart having no more than one interior vertical post on the side, having clear openings across any horizontally un-partitioned space, or having no vertical posts within the width of a door.

2. A process for killing poultry comprising steps of putting birds into a cart, moving the cart to a killing area, killing the birds, and dumping the birds out of the cart.

3. A process or apparatus having any novel and inventive feature or combination of features described herein.
